(19) United States
(12) Patent Application Publication
(10) Pub. No.: US 2025/0092901 A1
(43) Pub. Date: Mar. 20, 2025

(54) FIXING METHOD

(71) Applicant: TOYOTA JIDOSHA KABUSHIKI KAISHA, Toyota-shi (JP)

(72) Inventors: Kohei HISADA, Nagoya-shi (JP); Takashi SAKUI, Nagoya-shi (JP)

(73) Assignee: TOYOTA JIDOSHA KABUSHIKI KAISHA, Toyota-shi (JP)

(21) Appl. No.: 18/809,429

(22) Filed: Aug. 20, 2024

(30) Foreign Application Priority Data
Sep. 15, 2023 (JP) 2023-150198

(51) Int. Cl. F16B 19/02

(52) U.S. Cl. CPC F16B 19/02

(57) ABSTRACT

A fixing method capable of preventing first and second members from being damaged when the first and second member are fixed to each other with pins is provided. A fixing method includes an alignment step of aligning a plurality of holes formed in the first member with a plurality of corresponding holes formed in the second member, an insertion step of inserting an expandable pin into each of a plurality of pairs of holes each of which consists of one of the holes of the first member and one of the holes of the second member aligned with each other, and a correction step of correcting misalignment between the holes of the first member and the holes of the second member by expanding the expandable pins, and maintaining a positional relationship between the first and second members.

### CROSS REFERENCE TO RELATED APPLICATIONS

This application is based upon and claims the benefit of priority from Japanese patent application No. 2023-150198, filed on Sep. 15, 2023, the disclosure of which is incorporated herein in its entirety by reference.

### BACKGROUND

The present disclosure relates to a method for fixing a first member and a second member to each other by using a pin.

There are cases where a first member and a second member are fixed to each other by inserting pins into holes of the first and second members. For example, in a temporary fixing mechanism disclosed in Japanese Unexamined Patent Application Publication No. H4-151011, a housing and a cam plate are fixed to each other by inserting the tips of pins that are already inserted into holes formed in the housing into holes formed in the cam plate positioned in a predetermined rotational position.

### SUMMARY

The applicant of the present application has found the following problem. In general, there are many cases in which when a first member and a second member are fixed to each other by pins, the holes of the first member and those of second member are misaligned. In such cases, the pins are forcibly inserted into the holes of the first and second members, for example, by using a hammer or the like. As a result, the first or second member may be damaged.

The present disclosure has been made in view of such a problem, and provides a fixing method capable of preventing first and second members from being damaged when the first and second member are fixed to each other with pins.

A fixing method according to an aspect of the present disclosure is a method for fixing a first member and a second member to each other with pins, including:
an alignment step of aligning a plurality of holes formed in the first member with a plurality of corresponding holes formed in the second member;
a first insertion step of inserting an expandable pin into each of a plurality of pairs of holes each of which consists of one of the holes of the first member and one of the holes of the second member aligned with each other; and
a correction step of correcting misalignment between the holes of the first member and the holes of the second member by expanding the expandable pins, and maintaining a positional relationship between the first and second members.

When each of the first and second members includes at least three holes, the above-described fixing method preferably further includes a fixing step of repeating a second insertion step, the second insertion step being a step of contracting one of the expandable pins, pulling out the contracted expandable pin from its corresponding pair of holes, and inserting a fixing pin in this pair of holes in a state in which one of the other expandable pins or a fixing pin has been inserted in each of the other pairs of holes.

In the above-described fixing method, the correction step preferably includes simultaneously expanding the expandable pins inserted into the respective pairs of holes, and successively stopping the expansions of the expandable pins starting from an expandable pin inserted in a pair of holes formed in the first and second members of which misalignment has been corrected.

In the above-described fixing method, it is preferable that a diameter of each of the expandable pins can be increased.

In the above-described fixing method, an outer diameter of a part of the expandable pin having a largest diameter in a state in which the expandable pin is contracted is preferably smaller than diameters of the holes of the first and second members, and
an outer diameter of a part of the expandable pin having a largest diameter in a state in which the expandable pin is expanded is preferably equal to or larger than the diameters of the holes of the first and second members.

According to the present disclosure, it is possible to provide a fixing method capable of preventing first and second members from being damaged when the first and second member are fixed to each other with pins.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 shows a state in which a fixing pin is inserted into a hole of a first member and a hole of a second member in a fixing step of a fixing method according to an embodiment;

FIG. 2 is a flowchart showing a flow of the fixing method according to an embodiment;

FIG. 3 shows a state in which a first member and a second member are arranged in an alignment step of a fixing method according to an embodiment;

FIG. 4 is a diagram for explaining a state in which an expandable pin, which has been inserted into a hole of a first member and a hole of a second member, is expanded in a correction step of a fixing method according to an embodiment; and

FIG. 5 shows an example of an expandable pin used in a fixing method according to an embodiment.

### DESCRIPTION OF EMBODIMENTS

Specific embodiments to which the present disclosure is applied will be described hereinafter in detail with reference to the drawings. However, the present disclosure is not limited to the below-shown embodiments. Further, the following description and drawings are simplified as appropriate for clarifying the explanation. Note that the following description will be given by using a three-dimensional (XYZ) coordinate system for clarifying the explanation.

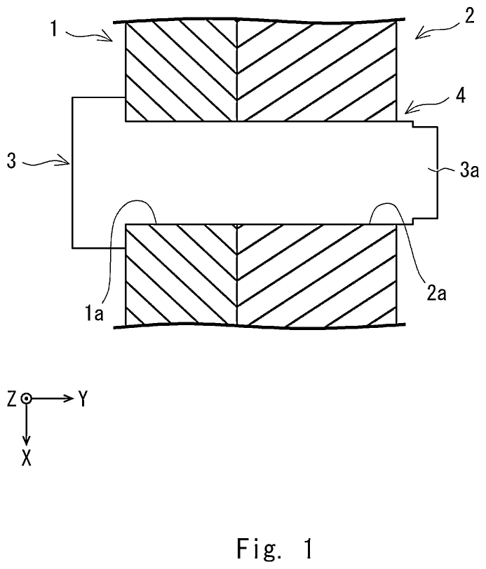

FIG. 1 shows a state in which a fixing pin is inserted into a hole of a first member and a hole of a second member in a fixing step of a fixing method according to an embodiment. As shown in FIG. 1, the fixing method according to this embodiment is suitable, for example, when a first member 1 and a second member 2 are fixed to each other by inserting fixing pins 3 into three or more holes 1a formed in the first member 1 and three or more holes 2a formed in the second member 2, respectively.

The first member 1 is, for example, a flexible member such as a long member or a large member. For example, four brackets that are arranged to be spaced from each other in the Y-axis direction and in the X-axis direction are provided in the first member 1, and a roughly circular hole 1a is formed in each bracket so as to penetrate the bracket in the Y-axis direction.

The second member 2 is, for example, a flexible member such as a long member or a large member. For example, four brackets that are arranged to be spaced from each other in the Y-axis direction and in the X-axis direction are provided in the second member 2, a roughly circular hole 2a is formed in each bracket so as to penetrate the bracket in the Y-axis direction.

Each of the holes 1a of the first member 1 and a respective one of the holes 2a of the second member 2 form a pair of holes 4 as shown in FIG. 1, and can be arranged so that, for example, the central axes of the holes of the members are aligned with each other. Further, for example, the diameter of the hole 1a of the first member 1 is roughly equal to that of the hole 2a of the second member 2.

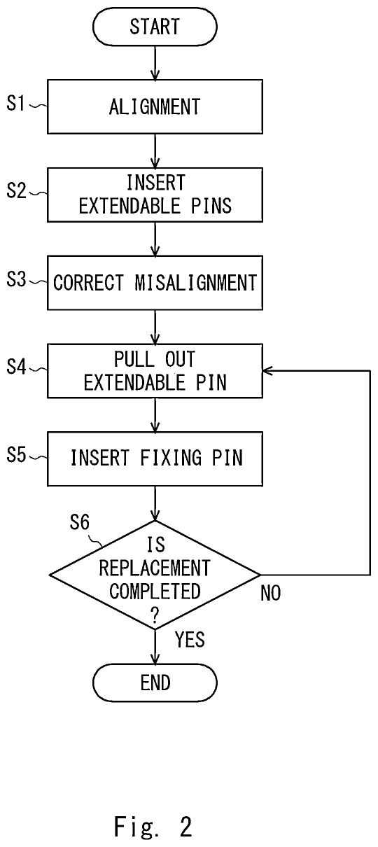

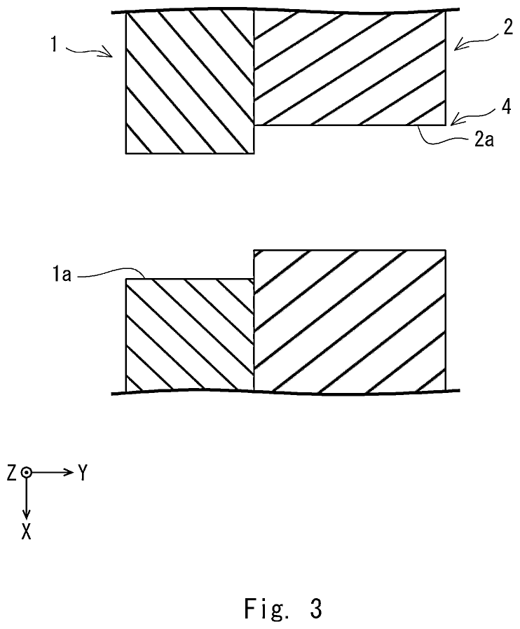

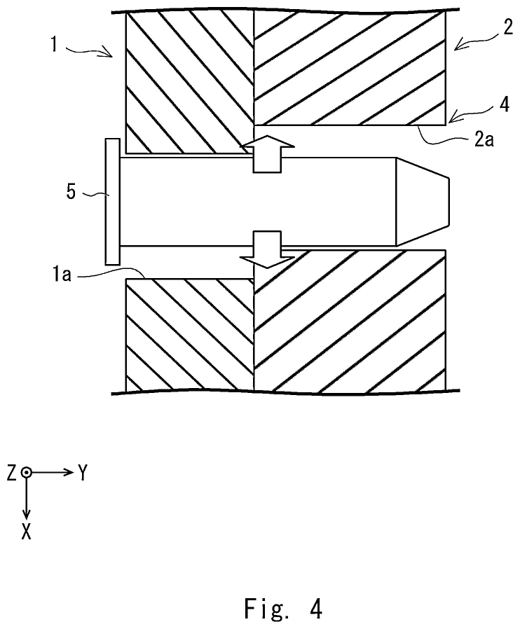

FIG. 2 is a flowchart showing a flow of a fixing method according to this embodiment. FIG. 3 shows a state in which a first member and a second member are arranged in an alignment step of the fixing method according to this embodiment. FIG. 4 is a diagram for explaining a state in which an expandable pin, which has been inserted into a hole of the first member and a hole of the second member, is expanded in a correction step of the fixing method according to this embodiment.

Firstly, as shown in FIG. 3, a first member 1 and a second member 2 are arranged, and a hole 1a in the first member 1 and a hole 2a in the second member 2, which form a pair of holes 4, are aligned with each other (S1). In this process, in the case where, for example, the first and second members 1 and 2 are flexible members, the holes 1a and 2a of the first and second members 1 and 2 are likely to be misaligned.

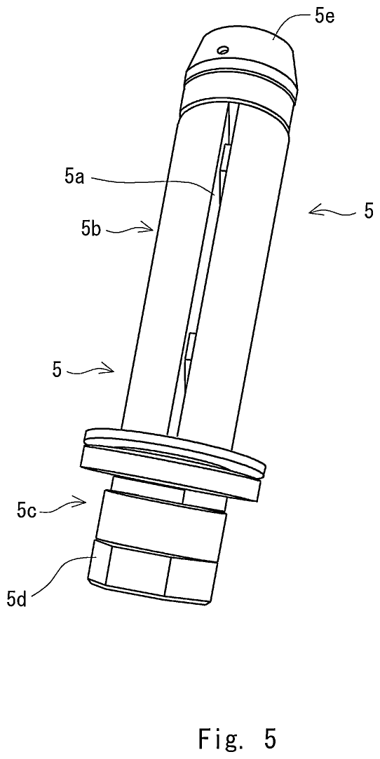

Next, as shown in FIG. 4, an expandable pin 5 is inserted into each of the pairs of holes 4 (S2). Note that FIG. 5 shows an example of an expandable pin used in the fixing method according to this embodiment. For example, an ordinary expandable pin can be used as the expandable pin 5.

For example, as shown in FIG. 5, the expandable pin 5 has a structure in which a cylindrical part 5b in which a slit 5a is formed is inserted into a shaft part of a bolt 5c, and the cylindrical part 5b is positioned between a bolt head 5d of the bolt 5c and a cap nut 5e screwed into the tip of the shaft part of the bolt 5c.

Further, regarding the expandable pin 5, when the bolt 5c is rotated, an inclined surface formed on the inner peripheral surface of the cylindrical part 5b comes into contact with an inclined surface formed on the peripheral surface of the shaft part of the bolt 5c, so that the diameter of the cylindrical part 5b increases.

Note that the outer diameter of the cylindrical part 5b in a state in which the diameter of the cylindrical part 5b of the expandable pin 5 is reduced as much as possible (i.e., the diameter is not increased at all) is smaller than the diameter of the hole 1a of the first member 1 and that of the hole 2a of the second member 2.

Therefore, when the misalignment between the holes 1a and 2a of the first and second members 1 and 2 is within a predetermined range, the expandable pin 5 can be easily inserted into the holes 1a and 2a of the first and second members 1 and 2 as shown in FIG. 4.

In contrast, the outer diameter of the cylindrical part 5b in a state in which the diameter of the cylindrical part 5b of the expandable pin 5 is increased as much as possible is equal to or larger than the diameter of the hole 1a of the first member 1 and that of the hole 2a of the second member 2. Therefore, in the state in which the diameter of the cylindrical part 5b of the expandable pin 5 is increased as much as possible, the outer peripheral surface of the cylindrical part 5b can come into contact with almost the entire peripheral surface of the hole 1a of the first member 1 and almost the entire peripheral surface of the hole 2a of the second member 2.

Next, as shown in FIG. 4, the misalignment between the holes 1a and 2a of the first and second members 1 and 2 is corrected by increasing the diameter of the cylindrical part 5b of the expandable pin 5 (S3). That is, the misalignment between the holes 1a and 2a of the first and second members 1 and 2 is corrected by increasing the diameter of the cylindrical part 5b of the expandable pin 5, and thereby moving one of the members while using the reactive force from the other member. By doing so, the holes 1a and 2a of the first and second members 1 and 2 are arranged so that, for example, the central axes of the holes of the members are roughly aligned with each other.

By increasing the diameter of the cylindrical part 5b of the expandable pin 5 as described above, the misalignment between the holes 1a and 2a of the first and second members 1 and 2 can be corrected, so that the first and second members 1 and 2 can be prevented from being damaged. Further, since the expandable pin 5 has such a structure that its diameter can be increased, it is possible to make the loads on the expandable pin 5, the first member 1, and the second member 2 uniform compared with the case where the pin is partially expanded.

Note that regarding the plurality of pairs of holes 4, the amount of the misalignment between the pairs of holes 1a and 2a of the first and second members 1 and 2 differ from one pair to another. Therefore, it is preferable that the diameters of the cylindrical parts 5b of the expandable pins 5 inserted into the respective pairs of holes 4 be simultaneously increased, and the increasing of the diameters of the cylindrical parts 5b be successively stopped starting from an expandable pin 5 inserted in a pair of holes 4, which consists of holes 1a and 2a, formed in the first and second members 1 and 2 of which the misalignment between the holes 1a and 2a has been corrected.

In this way, it is possible to reduce the loads on the expandable pin 5, the first member 1, and the second member 2 and to reduce the imbalance of the misalignment among the plurality of pairs of the first and second holes 1a and 2a of the first and second members 1 and 2 compared with the case where the misalignment of each of the pairs of the first and second holes 1a and 2a of the first and second members 1 and 2 is individually corrected.

Next, for example, in a state in which one of the diameter-increased expandable pins 5 or a fixing pin 3 has been inserted into each of three pairs of holes 4, the diameter of the cylindrical part 5b of the expandable pin 5 inserted into one of the other pairs of holes 4 is reduced, and this expandable pin 5 is pulled out from this pair of holes 4 (S4). Then, as shown in FIG. 1, a fixing pin 3 is inserted into the pair of holes 4 from which the expandable pin 5 has been pulled out (S5).

Note that regarding the three pairs of holes 4, the positional relationship between the first and second members 1 and 2, in which the misalignment between the holes 1a and 2a of the first and second members 1 and 2 has been corrected by the diameter-increased expandable pin 5 or the fixing pin 3, is maintained. Therefore, even the pair of holes 4 in which the expandable pin 5 has been removed is maintained in the state in which the misalignment between the holes 1a and 2a of the first and second members 1 and 2 has been corrected.

As a result, the fixing pin 3 can be smoothly inserted into the holes 1a and 2a of the first and second members 1 and 2. Therefore, there is no need to forcefully insert a fixing pin 3 by using a hammer or the like as being performed when a pin is inserted into a hole of a first member and a hole of a second member in an ordinary manner, so that it is possible to prevent the first and second members 1 and 2 from being damaged.

Note that the fixing pin 3 is preferably, for example, a bolt of which the diameter of the shaft part 3a of the fixing pin 3 (i.e., the bolt) is roughly equal to the diameter of the hole 1a of the first member 1 and that of the hole 2a of the second member 2. However, the fixing pin 3 may have any structure as long as the first and second members 1 and 2 can be fixed to each other in the state in which the fixing pin 3 is inserted into the holes 1a and 2a of the first and second members 1 and 2.

Next, it is determined whether or not all the expandable pins 5 have been replaced with fixing pins 3 (S6). When any of the expandable pins 5 has not been replaced with a fixing pin 3 (No in S6), the process returns to the step S4. On the other hand, when all the expandable pins 5 have been replaced with fixing pins 3 (Yes in S6), the fixing of the first and second members 1 and 2 is completed. Note that when the fixing pin 3 is, for example, formed of a bolt, the first and second members 1 and 2 can be fixed to each other by fastening a nut around the bolt.

As described above, in the fixing method according to this embodiment, the misalignment between the holes 1a and 2a of the first and second members 1 and 2 can be corrected by using expandable pins 5, and the positional relationship between the first and second members 1 and 2 is maintained. That is, there is no need to forcibly insert a pin into the holes 1a and 2a of the first and second members 1 and 2 by using a hammer or the like in order to correct misalignment between the holes of the members, so that it is possible to prevent the first and second members 1 and 2 from being damaged.

In particular, even when the first and second members 1 and 2 are flexible members, and the amounts of the misalignment between the pairs of holes 1a and 2a of the first and second members 1 and 2 differ from one pair to another, it is possible to easily correct the misalignment between the holes 1a and 2a of the first and second members 1 and 2.

Further, in the fixing method according to this embodiment, the diameter-increased expandable pin 5 inserted into one of the plurality of pairs of holes 4 is replaced with a fixing pin 3 in a state in which one of the other expandable pins 5 or a fixing pin 3 has been inserted into each of the other pairs of holes 4. Note that regarding the plurality of pairs of holes 4, the positional relationship between the first and second members 1 and 2, in which the misalignment between the holes 1a and 2a of the first and second members 1 and 2 has been corrected by the diameter-increased expandable pin 5 or the fixing pin 3, is maintained.

Therefore, even the pair of holes 4 from which the expandable pin 5 has been removed is maintained in the state in which the misalignment between the holes 1a and 2a of the first and second members 1 and 2 has been corrected. As a result, the fixing pin 3 can be smoothly inserted into the holes 1a and 2a of the first and second members 1 and 2. Therefore, there is no need to forcefully insert a fixing pin 3 in the holes 1a and 2a of the first and second members 1 and 2 by using a hammer or the like, so that it is possible to prevent the first and second members 1 and 2 from being damaged.

Note that, in general, there are cases where in a state in which members are positioned relative to each other (e.g., aligned with each other) by inserting positioning pins provided in one of the members into positioning holes formed in the other member, the members are fixed to each other by inserting fixing pins into fixing holes formed in one of the members and those formed in the other member. In such cases, it is troublesome to insert each positioning pin into a respective positioning hole, and in addition, the positioning pins remain after the members are fixed to each other, so that their weight increases.

In contrast, in the fixing method according to this embodiment, since the expandable pins 5 can be easily inserted into the holes 1a and 2a of the first and second members 1 and 2, the fixing work of the members is simple. In addition, since the expandable pins 5 are replaced with fixing pins 3, none of the expandable pins 5 remains after the members are fixed to each other, so that their weight can be reduced.

Further, in the case where the diameters of the cylindrical parts 5b of the expandable pins 5 inserted into the respective pairs of holes 4 are simultaneously increased, and the increasing of the diameters of the cylindrical parts 5b are successively stopped starting from an expandable pin 5 inserted in a pair of holes 4, which consists of holes 1a and 2a, formed in the first and second members 1 and 2 of which the misalignment between the holes 1a and 2a has been corrected, the loads on the expandable pin 5, the first member 1, and the second member 2 can be reduced, and the imbalance of the misalignment among the plurality of pairs of the first and second holes 1a and 2a of the first and second members 1 and 2 can be reduced compared with the case where the misalignment of each of the pairs of the first and second holes 1a and 2a of the first and second members 1 and 2 is individually corrected.

Note that in this embodiment, the number of each of the holes 1a and 2a of the first and second members 1 and 2 is four, but it is sufficient if the number is two or greater. Further, the first and second members 1 and 2 do not necessarily have to be flexible members, and their shapes and the positions of holes are not limited to any particular shapes and any particular positions.

Further, although the holes 1a and 2a of the first and second members 1 and 2 are arranged so that the central axes of the holes are roughly aligned with each other in this embodiment, the holes 1a and 2a of the first and second members 1 and 2 may be, for example, obliquely arranged with respect to the Y-axis. Further, although the diameters of the holes 1a and 2a of the first and second members 1 and 2 are roughly equal to each other in this embodiment, the diameters of holes of the members may be different from each other and their shapes do not necessarily have to be circular.

Further, although the expandable pins 5 each having such a structure that its diameter can be increased are used in this embodiment, expandable pins 5 each of which is partially expandable may be used. Further, the means for expanding an expandable pin 5 is not limited to the above-described structure. That is, the expandable pin 5 may be expanded, for example, by using an elastic member such as a spring, or by using air or a hydraulic pressure. Further, the expandable pin 5 may be changed (e.g., modified) as appropriate according to, for example, the shapes of the holes 1a and 2a of the first and second members 1 and 2.

In short, the shapes of the holes 1a and 2a of the first and second members 1 and 2 and the structure of the expandable pin 5 are not limited to any particular shapes and any particular structures as long as it is possible to correct the misalignment between holes of the members so that a fixing pin 3 can be inserted into the holes 1a and 2a of the first and second members 1 and 2.

Further, although the expandable pins 5 are replaced with fixing pins 3 in this embodiment, the first and second members 1 and 2 may be permanently fixed to each other by using the expandable pins 5 without replacing them with fixing pins 3.

The present disclosure is not limited to the above-described embodiments, and they can be modified as appropriate without departing from the scope and spirit of the disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A fixing method for fixing a first member and a second member to each other with pins, comprising:
an alignment step of aligning a plurality of holes formed in the first member with a plurality of corresponding holes formed in the second member;
a first insertion step of inserting an expandable pin into each of a plurality of pairs of holes each of which consists of one of the holes of the first member and one of the holes of the second member aligned with each other; and
a correction step of correcting misalignment between the holes of the first member and the holes of the second member by expanding the expandable pins, and maintaining a positional relationship between the first and second members.

2. The fixing method according to claim 1, wherein when each of the first and second members includes at least three holes, the fixing method further comprises a fixing step of repeating a second insertion step, the second insertion step being a step of contracting one of the expandable pins, pulling out the contracted expandable pin from its corresponding pair of holes, and inserting a fixing pin in this pair of holes in a state in which one of the other expandable pins or a fixing pin has been inserted in each of the other pairs of holes.

3. The fixing method according to claim 1, wherein the correction step comprises simultaneously expanding the expandable pins inserted into the respective pairs of holes, and successively stopping the expansions of the expandable pins starting from an expandable pin inserted in a pair of holes formed in the first and second members of which misalignment has been corrected.

4. The fixing method according to claim 1, wherein a diameter of each of the expandable pins can be increased.

5. The fixing method according to claim 1, wherein
an outer diameter of a part of the expandable pin having a largest diameter in a state in which the expandable pin is contracted is smaller than diameters of the holes of the first and second members, and
an outer diameter of a part of the expandable pin having a largest diameter in a state in which the expandable pin is expanded is equal to or larger than the diameters of the holes of the first and second members.
